(19) United States
(12) Patent Application Publication
(10) Pub. No.: US 2009/0099407 A1
(43) Pub. Date: Apr. 16, 2009

(54) SALT ROOM AND A METHOD FOR COATING THE WALL/CEILING OF A SALT ROOM

(76) Inventor: Kari Viherlahti, Nummela (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 12/159,325

(22) PCT Filed: Dec. 18, 2006
(86) PCT No.: PCT/FI06/00411

§ 371 Date: Nov. 24, 2008

(30) Foreign Application Priority Data
Dec. 27, 2005 (FI) 20051328

(51) Int. Cl. A61G 10/00; B05D 1/06

(52) U.S. Cl. 600/21; 427/203

(57) ABSTRACT

The interior surface of one or more walls/ceiling of the salt room is composed of inner, intermediate and outer layers. In the salt room, the salt is attached to the interior surfaces as an outer layer with an underlying intermediate layer containing salt and adhesive agent and acting as a binding agent. A binding agent is spread onto the interior surfaces of the walls of the salt room on top of the moisture insulator. Into the binding agent are embedded salt granules, after which to the binding agent surfaces containing salt granules an adhesive layer is added, which penetrates into the binding agent and attaches to the salt granules. Salt is spread on the adhesive layer as a porous coating, wherein the adhesive agent holds on to the salt layer in the binding agent surface.

### TECHNICAL FIELD

The invention relates to a salt room, the wall/ceiling interior surfaces of which are lined with salt, and a method for coating the walls of the salt room.

### BACKGROUND ART

A salt room treatment is given, as per its name, in a room lined with salt. The salt layer in the wall coatings, in the ceiling and floor causes a strong negative ionization of the room air, which for its part eases respiration.

The salt dust in the alveolar air has an infection-reducing and phlegm-detaching influence in the respiratory ducts. It thins thickened mucous membranes and for this part eases respiration. The dry salt dust also penetrates efficiently into the farthest reaches of the respiratory ducts. When caught in the skin pores, the salt dust sucks moisture into itself from the surrounding air. Due to this, the skin remains moisturized and elastic. At the same time the salt also has a disinfecting influence. The amount of salt that travels into the system during the salt room treatment is so small that it does not cause additional swelling or increase in blood pressure. A salt room treatment session lasts about 40 min at a time. With small children or in difficult cases, the first treatment sessions last 5-10 min.

When the treatment has ended, the exhaust suction fan exchanges the interior air of the room and at the same time removes the carbon dioxide that has accumulated due to respiration. Exhaust air is conducted directly out or is blown through a filter into the air surrounding the room.

By using a salt generator, a fine salt dust is produced in the alveolar air. The generator automatically measures out the correct amount of salt and the nearly diamond-sharp blade grinds the salt granule into an invisible dust and blows it into the alveolar air of the room. During the treatment, a very fine salt dust made with the so-called salt generator from pure salt (NaCl) is blown into the air of the room, wherein there is approximately 0.5-10 mg/m³ of salt particles in the alveolar air.

The salt content is thus achieved in the alveolar air both by measuring out with the salt generator and by lining the interior surfaces of the salt room with salt.

The first salt rooms were built of bricks cut from salt rock. The newest salt rooms are built from elements. The surfaces of the ceiling and walls are coated using sheets coated with salt and loose salt is spread on the floor. Yet in one alternative, the walls and ceiling are coated on the inside of the salt room with a raw board, to which is attached a steel netting to hold on to the salt layer. Onto the surface of the raw board and the steel netting is sprayed a solution made of sodium silicate and water, which acts as an adhesive layer. The surface is roughcast or granular rock salt moistened with water is spread on it. When the first layer has dried, spreading of the adhesive solution and addition of the salt layer is repeated. To the surface of the walls and ceiling 3-4 layers of rock salt are added in the manner previously described, because the netting would not otherwise be covered and colour agents released from the board would not otherwise have become invisible. The final drying of the walls and ceiling takes 2-3 weeks. Additionally, moisture is absorbed into the frame structures of the room, thus slowing the drying.

The prior art method is thus very complex, because getting the salt layer to stay on the walls has been a disadvantage.

### SUMMARY OF THE INVENTION

The composition of the interior surfaces of the walls/ceiling of a salt room according to the invention is new, and the interior surfaces are lined with salt in a new manner. The interior surface of one or more walls/ceiling of the salt room is composed of inner, intermediate and outer layers. In the salt room, the salt is attached to the interior surfaces as an outer layer with an underlying intermediate layer containing salt and adhesive agent and acting as a binding agent.

In a method according to the invention, onto the interior surfaces of the walls of the salt room is spread binding agent on top of the moisture insulator. Into the binding agent are embedded salt granules, after which to the binding agent surfaces containing salt granules an adhesive layer is added, which penetrates into the binding agent and attaches to the salt granules. Salt is spread on the adhesive layer as a porous coating, wherein the adhesive agent holds on to the salt layer in the binding agent surface.

The preferred embodiments of the invention have the characteristic features according to subclaims.

The salt, which forms the outer layer of the interior surfaces of the wall, can be thinner than before due to the underlying intermediate layer containing salt and adhesive agent and acting as a binding agent.

The interior walls and ceiling of a salt room according to the invention can be composed of element, sheet or board materials of wood or plaster. Their inner layer is formed from a moisture-insulating coating, the intermediate layer is made of a water-insoluble paint or paste acting as a binding agent, to which is added a salt granule layer as well as an adhesive layer penetrating into the paint and binding to the salt granules, and the thickness of the outer layer formed from salt is 2-20 mm, preferably 5-10 mm. The adhesive agent is, for example, sodium silicate.

By using the invention, a clear advantage is achieved, as the coating method according to prior art required from 2 weeks to 3 weeks to be completed, because only after this were the surfaces dry and the room in working order. By using the coating method of the invention, the room is in working order in 3-4 days time. Moisture and paint insulation prevents the base material from discolouring the salt layer itself.

The surfaces of the walls and ceiling do not need netting, because the salt anchors to the white paint layer impregnated with salt using sodium silicate more evenly than to the netting. Sodium silicate adheres to both the paint and the salt granules embedded therein from below as well as from above to the outer layer of salt.

In the following, the wall coating of a salt room according to the invention is illustrated by means of figures by comparing the invention to the structure of prior art. The presentation is not intended to limit the invention in any way.

### FIGURES

FIG. 1 shows the coating of the interior wall of a salt room according to prior art.

FIG. 2 shows the coating of the interior wall of a salt room according to the invention.

FIG. 3 shows in greater detail the coating of the interior wall of a salt room according to the invention.

### DETAILED DESCRIPTION

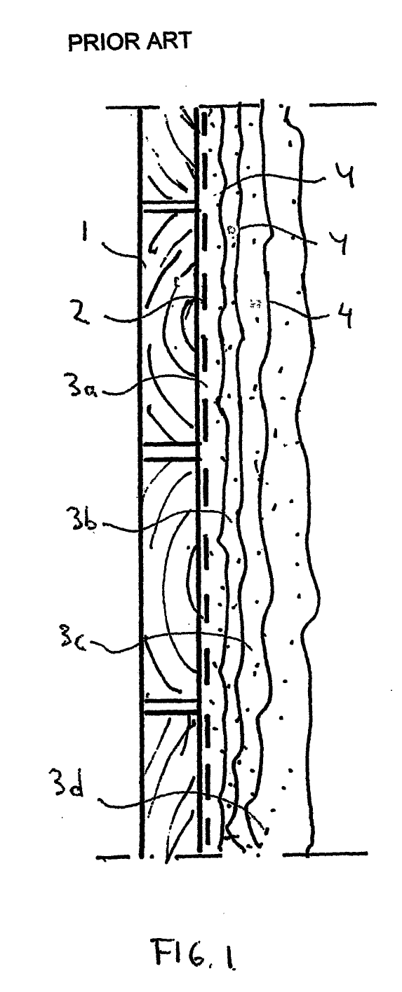

FIG. 1 shows the coating of the interior wall of a salt room according to prior art. The walls and ceiling are coated on the inside of the salt room with a raw board 1, to which is attached a steel netting 2 to hold on to the salt layers. Onto the surface of the raw board 1 and the steel netting 2 is sprayed a solution made of sodium silicate and water, which acts as an adhesive layer. The surface is roughcast or the granular rock salt 3a moistened with water is spread on it. When the first layer 3a has dried, spreading of the adhesive solution and addition of the salt layer 3b is repeated. To the surfaces of the walls and ceiling are added 3-4 layers of rock salt 3c-3d in the manner previously described, because the netting 2 would not otherwise be covered and colour agents released from the board would not otherwise have become invisible. To each salt layer 3a-3c, except for the topmost one, sodium silicate 4 must also be added and only the topmost salt layer 3d is porous. Porosity is important, as due to it the ionization becomes more effective and because the salt layer then has a greater surface area. The final drying of the walls and ceiling takes 2-3 weeks.

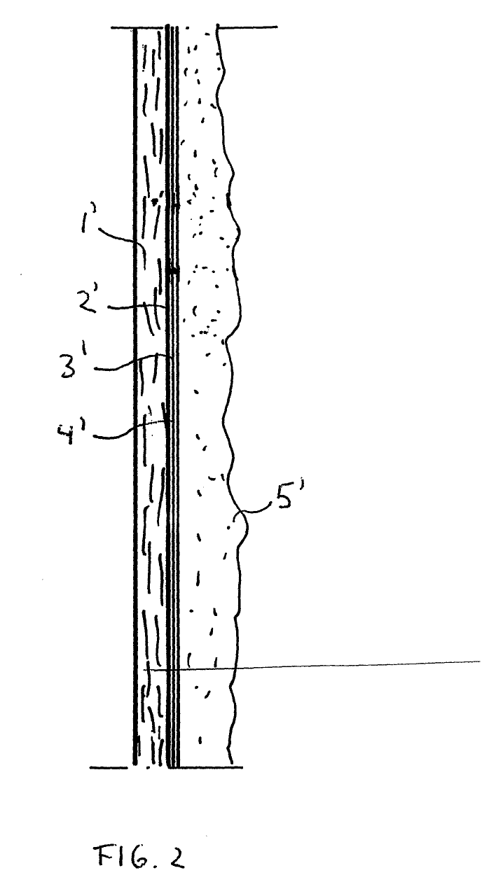

FIG. 2 shows the coating of the interior wall of a salt room according to the invention. The interior walls of the salt room are made, for example, from the elements of wood or plaster, or the walls and ceiling are coated with a sheet or board material 1′, which is made of wood or plaster. The seams are taped using sealing strips (not shown) and at the same time the surfaces are coated with moisture-insulating material 2′.

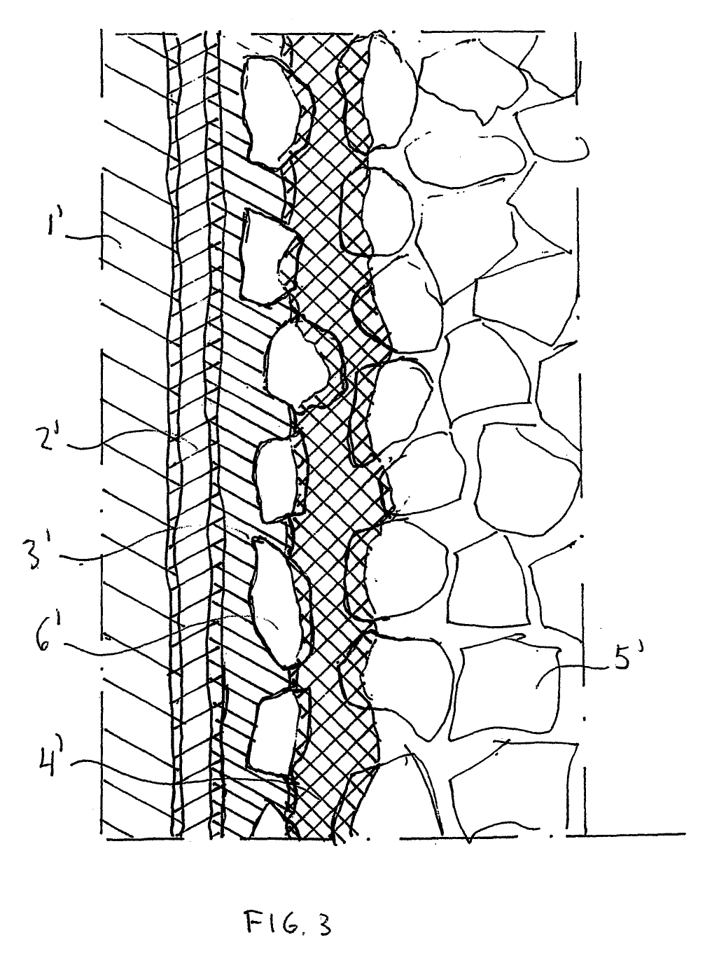

When the moisture insulator has dried, the wall and ceiling surfaces are painted using a white, water-insoluble paint or paste 3′. While the paint is still fresh, a dry salt granule layer (reference number 6′ can be seen in FIG. 3) is spread/roughcast on the painted surfaces.

When the paint has dried, a mixture of sodium silicate and water is sprayed on the surfaces as an adhesive layer 4′, and immediately after this, one layer of rock salt 5′ moistened with water is spread or roughcast on them. When the salt layer has dried, the wall and ceiling surfaces are ready.

FIG. 3 shows in greater detail as a salt wall cross-section the coating of the interior wall of a salt room according to the invention. In FIG. 3 are shown the sheet or board material 1′, the moisture insulator 2′, the paint or paste 3′, and the adhesive layer 4′ of sodium silicate and water.

In FIG. 3 can be more clearly seen than in FIG. 2 the salt granules 6′ embedded in the binding agent 3′. To the binding agent surfaces 3′ containing salt granules 6′ is added an adhesive layer 4′, which penetrates into the binding agent 3′ and attaches to the salt granules 6′. On the adhesive layer 4′ is spread salt 5′ as a porous coating, wherein the adhesive agent 4′ holds on to the salt layer 5′ in the binding agent surface 3′.

By using the invention, a clear advantage is achieved, as the coating method according to prior art required from 2 weeks to 3 weeks to be implemented. Only after this were the surfaces dry and the room in working order. By using the coating method of the invention, the room is in working order in 3-4 days time. Additionally, by using the invention, a significant material savings is achieved.

1. A salt room, comprising:
interior walls/ceiling being lined with salt,
the interior walls/ceiling being composed of inner, intermediate and outer layers, in which the inner layer is being formed from a moisture-insulating coating and salt is being attached to interior surfaces of the walls/ceiling as an outer layer on an underlying intermediate layer containing salt and an adhesive agent (4′),
the underlying intermediate layer being made of a water-insoluble paint or paste acting as a binding agent, to which has been added a salt granule layer and an adhesive layer penetrating into the water-insoluble paint and binding to the salt granule layer.

2. A salt room according to claim 1, wherein the interior walls/ceiling are composed of element, sheet or board materials of wood or plaster.

3. A salt room according to claim 1, wherein the adhesive agent is sodium silicate.

4. A salt room according to claim 1 wherein a thickness of the outer layer formed from salt is 2-20 mm, preferably 5-10 mm.

5. A method for lining interior walls/ceiling of a salt room with salt,
coating the interior walls/ceiling with a moisture insulator,
hardening the moisture insulator
spreading a binding agent, which is a water-insoluble paint or paste, over surfaces of the moisture insulator,
embedding salt granules into the binding agent
adding an adhesive layer to surfaces of the binding agent
the adhesive layer penetrating into the binding agent and attaching to the salt granules, and
spreading salt over the adhesive layer to form a porous coating,
the adhesive agent holding on to the salt in the surfaces of the binding agent.

6. A method according to claim 5, claim 5 wherein the method further comprises making the interior walls/ceiling from element, sheet or board materials of wood or plaster.

7. A method according to claim 5 wherein the method further comprises spreading a dry salt granule layer on the binding agent before the surfaces of the binding agent has dried, wherein the salt granules become embedded in the binding agent.

8. A method according to claim 5 wherein the method further comprises spraying a mixture of sodium silicate and water on the surfaces of the binding agent, wherein the sodium silicate binds to both the binding agent and the salt granules.

9. A method according to claim 5 wherein the method further comprises spreading one more layer of moistened salt on top of the porous coating.
